(19) United States
(12) Patent Application Publication
(10) Pub. No.: US 2007/0267358 A1
(43) Pub. Date: Nov. 22, 2007

(54) Online poultry reprocessing tablet chlorination system and method

(76) Inventors: James D. Stanford, Conyers, GA (US); W. Neal Stanford, Conyers, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/827,680

(22) Filed: Jul. 12, 2007

Related U.S. Application Data
(62) Division of application No. 10/827,003, filed on Apr. 19, 2004.

(51) Int. Cl. C02F 1/76

(52) U.S. Cl. 210/754

(57) ABSTRACT

An automated online processing super-chlorination system that monitors the chlorine levels as well as the pH levels of a main water line. Super-chlorinated water is implemented in processing water to allow poultry to be reprocessed online without removing the poultry to an offline location. The use of super-chlorinated water allows much of the pathogens of concern to be removed from the poultry while online. Chambers including jets injecting the super-chlorinated water onto the poultry as well as brushes allows actual removal of waste and fecal matter, while at the same time, sanitizing the poultry. A control section includes a chlorine and pH analyzer as well as control units to allow chlorine and pH levels to be continuously monitored and adjusted. A chlorinator and a pH adjustment system are controlled in order to inject the proper chemicals at needed and specified times.

### CROSS-REFERENCES TO RELATED APPLICATIONS

To the fullest extent permitted by law, the present U.S. Non-Provisional patent application claims priority to, and the full benefit of, U.S. Non-Provisional patent application having assigned Ser. No. 10/827,003 filed Apr. 19, 2004, entitled “Online Poultry Reprocessing Tablet Chlorination System and Method”.

### TECHNICAL FIELD

The present invention relates generally to the field of poultry processing and, more particularly, to an online system and method of providing super-chlorinated water for reprocessing poultry online.

### BACKGROUND OF THE INVENTION

In present poultry processing systems, carcasses are placed on eviscerating lines and go through a series of processing steps to prepare the birds for end consumers. Typically, a USDA inspector is placed on the eviscerating lines and inspects birds for compliance, which includes, among other things, the presence of disease and fecal matter. If a bird does not meet criteria set by the USDA, the inspector removes the bird from the processing line.

When the bird is removed from the processing line, the bird is now offline and is rehanged for offline processing that can include manual removal of diseased portions and manual removal of fecal matter and other contaminates. When the bird is processed offline, additional time and labor is required to manually process the bird.

### BRIEF SUMMARY OF THE INVENTION

In general, the invention features an online system and method for reprocessing poultry carcasses hanging on a processing line without having to remove and rehang the carcasses manually. One main feature that allows the online reprocessing of the poultry is the use of super-chlorinated water in the main water line used to clean the poultry while it is still online. The use of super-chlorinated water allows much of the pathogens of concern to be removed from the poultry while online. The use of chambers including jets injecting the super-chlorinated water onto the poultry as well as the use of brushes allows actual removal of waster and fecal matter, while at the same time, sanitizing the poultry. The water is super-chlorinated by an automated system that monitors the chlorine levels as well as the pH levels of the main water line. A control section includes, among other things, a chlorine and pH analyzer as well as control units to allow chlorine and pH levels to be continuously monitored and adjusted. A chlorinator and a pH adjustment system are controlled in order to inject the proper chemicals at needed and specified times.

In general, in one aspect, the invention features an online poultry reprocessing system, including a main flow water line, a bypass line having an inlet connected to an upstream portion of the main flow water line and an outlet connected to a downstream portion of the main flow water line, a chlorinator having an inlet connected the bypass line outlet and an outlet and a solution tank having an inlet connected to the chlorinator outlet and to the bypass line outlet and an outlet, wherein the solution tank outlet is connected to a downstream portion of the main flow water line.

In one implementation, the system further includes a water sample line connected to the main water flow line downstream of the downstream portion.

In another implementation, the system further includes a pH sensor line connected to the main water flow line down stream of the water sample line.

In another implementation, outlets of the water sample line and the pH sensor line are connected to an automated control section.

In another implementation, the control section includes a pH controller connected to the pH sensor line and a chlorine flow sensor connected to the water sample line.

In still another implementation, the automated control section controls a flow of water into the chlorinator and into the solution tank, and increases the flow into the chlorinator when chlorine in the water sample line falls below a threshold.

In yet another implementation, the solution tank receives a portion of water from the bypass line and a portion of chlorinated water from the chlorinator.

In another implementation, the system further includes pumps connected between the solution tank outlet and the downstream portion of the main flow water line.

In another implementation, the chlorinator includes a generally cylindrical housing having an upper chamber and a lower chamber, the chambers being separated by a sieve plate, wherein the lower chamber has a diameter smaller than the diameter of the upper chamber thereby forming an additional annular cavity around the perimeter of the lower chamber, a first pipe connected to the lower chamber and a second pipe connected to the annular cavity.

In another implementation, the first pipe is connected to the chlorinator inlet and the second pipe is connected to the chemical feeder outlet.

In another implementation, the system further includes a float valve located within the solution tank, the float valve controlling the flow of fresh make-up water into the solution tank.

In another implementation, the system further includes an injection point in the main water line connected at a point downstream of the water sample line and upstream of the pH sensor line.

In another implementation, the system further includes an injection pump connected to the injection point.

In another implementation, the system further includes a pH adjustment chemical located in the injection pump.

In another implementation, the pH adjustment chemical is sodium bisulfate. In another implementation, the pH adjustment chemical is citric acid.

In another implementation, the system further includes a chlorinating chemical located within the chlorinator.

In another implementation, the chlorinating chemical is calcium hypochlorite.

In another aspect, the invention features a method of providing super-chlorinated water to a poultry reprocessing system, including diverting a side stream of water from a main water flow line, channeling the diverted water through a chlorinator, injecting water from the chlorinator into the main water flow line and sampling water in a downstream location of the main water flow line for chemical levels.

In one implementation, the water sampled from the downstream location is sampled for chlorine levels.

In another implementation, the water sampled from the downstream location is sampled for pH levels.

In another implementation, the method further includes optionally injecting additional chlorinated water into the main water flow line.

In another implementation, the method further includes optionally injecting a pH adjustment chemical into the main water flow line.

One advantage of the invention is that soiled poultry can be processed online.

Another advantage is that the system provides super-chlorinated water to a poultry processing main water line.

Another advantage of the invention is that offline processing time is greatly reduced. Another advantage of the invention is that offline labor time is greatly reduced.

Another advantage of the invention is that chlorine and pH levels can be pre-established.

Another advantage of the invention is that chlorination of processing water is automatically monitored and adjusted to pre-established levels.

Other objects, advantages and capabilities of the invention will become apparent from the following description taken in conjunction with the accompanying drawings showing the preferred embodiment of the invention.

### BRIEF DESCRIPTION OF THE DRAWINGS

Having thus described the invention in general terms, the present invention will be better understood by reading the Detailed Description of the Preferred and Alternate Embodiments with reference to the accompanying drawing Figures, which are not necessarily drawn to scale, and in which like reference numerals denote similar structures and refer to like elements throughout, and in which:

FIG. 1 illustrates a system level diagram of an embodiment of an online poultry reprocessing tablet chlorination system; and

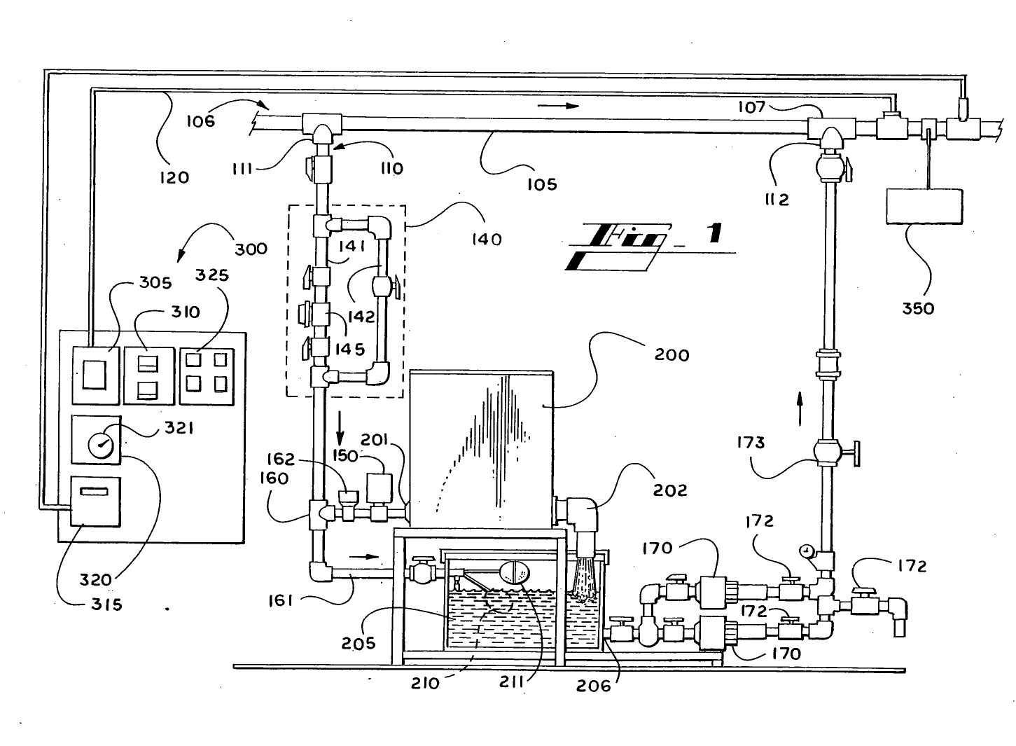

FIG. 2 illustrates a side view of an embodiment of a chlorinator.

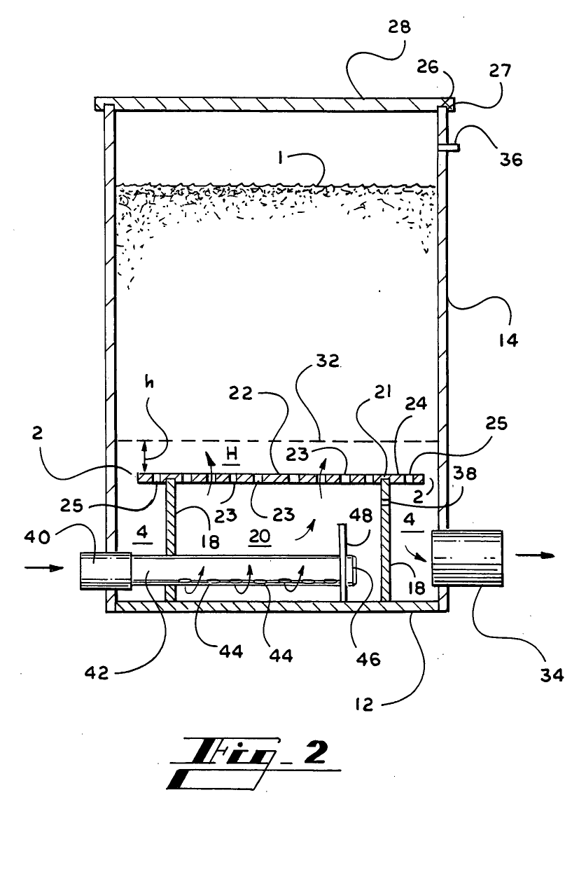

### DETAILED DESCRIPTION OF THE PREFERRED AND ALTERNATIVE EMBODIMENTS

Referring to the drawings wherein like reference numerals designate corresponding parts throughout the several figures, connected to the water line 105 at the upstream portion 106 and an outlet 112 of the bypass line 110 is connected at the downstream portion 107 of the water line 105. The inlet 111 is connected to a sub-loop 140 that includes two branches 141, 142. Branch 142 generally includes a ball valve 143 that can be manually handled to control the flow through branch 142. Branch 141 includes a solenoid valve 145 that is connected to a control section 300 (discussed further in the description below) . The branch 142 can further include one or more ball valves to control the flow through the branch 142. A side stream of water is diverted from the primary affluent and channeled through several parts of the system 100 and chlorinated to a specific residue using an automated process. The automated process closely maintains the residual that is injected back into the water line 105 at the downstream portion 107, where it is mixed with the primary affluent. The bypass line 110 generally defines a loop that includes a substantial part of the online poultry reprocessing tablet chlorination system 100, which is now described.

In general, the bypass line 110 allows a portion of water to flow into a chlorinator 200. The chlorinator 200 is used to control the chlorine levels of the water that flows downstream in the water line 105 to the online poultry process. It is typically desirable to have both the chlorine in the water line 105 and the overall pH of the water in the water line 105 be tested. As such, as water flows through the water line 105, a sample of the water is diverted into a chlorine analyzer line 120 and a pH analyzer line 130. The lines 120, 130 are typically tapped off the water line 105 downstream of the downstream portion 107 of the by pass line 110 to allow a sample to be taken after the system 100 has processed the water in the water line 105. The water in both of the chlorine analyzer line 120 and the pH analyzer line 130 is input into an automated control section 300.

The automated control section 300 includes a flow cell 305 with sensor that serves as a chlorine probe. The flow cell 305 is generally a container through which the diverted water flows. The chlorine analyzer line 120 is connected to the flow cell that receives the portion of the water to be measured for chlorine level. A chlorine analyzer 310 is connected to the flow cell 305. The chlorine analyzer 310 is used to measure the chlorine levels in the diverted water. The control section 300 further includes a pH controller 315 that is connected to the pH analyzer line 130. The pH controller 315 measures the pH of the diverted water as well as controls a pH adjustment pump 350 connected to the main water line at an injection point 351. The injection point 351 is located downstream of the chlorine analyzer line 120 and upstream of the pH analyzer line 130. It is typically desirable to have the pH analyzer line 130 upstream of the injection point 351 in order to properly analyze the pH of the affluent in the main water supply line 105. The pH controller 315 measures the pH level of the water and controls the pH adjustment pump 350 as described above. In a typical embodiment, citric acid solution of sodium bisulfate can be injected into the affluent in order to lower the pH levels as needed.

The control section 300 further includes a P.I.D. controller 330 connected to the chlorine analyzer 310. The F.I.D. controller 330 is electrically coupled to the actuated ball valve 150 in order to automatically control the flow through the bypass line 110 in general. Typically, when the system 100 is powered up, the solenoid valve 145 opens to allow water to flow through the bypass line 110 and through the chlorination and pH portions of the loop.

When the appropriate chlorine and pH levels are attained, the actuated ball value 150 can be properly controlled to modulate as the levels need adjustment. The controller 320 is further connected to an actuated ball valve 150 that generally controls the flow of the side stream into the chlorinator 200. The actuated ball valve 150 receives signals from the controller 320 and opens and closes depending on the desired chlorine levels in the main flow line 105. The controller 320 can further include a chart recorder 321 that records the chlorine levels on a suitable medium such as a round paper disc.

The control section 300 further includes an electronic control box 325 that includes all switches and starters for the entire control section 300. In general, the control box 325 is coupled to the other components of the control section 300 to coordinate the automated response of the section 300. In general, the flow of the side stream is analyzed for both chlorine and pH level in the control section 300. The controller 320 opens and closes the respective valves in order to allow more side stream to flow into the chlorinator 200 and the pH adjustment 350 if the chlorine and pH levels need adjustment in the main flow line 105.

The control section 300 is further coupled to injection pumps 170, which are discussed in further detail in the description below.

In general, the side stream water flows from the sub-loop 140 and further branches into the chlorination line 160 and the non-chlorination line 161. Water flowing into the chlorination line 160 flows through a digital flow meter 162 that measures how much water is flowing through the chlorination line 160 and ultimately into the chlorinator 200. After flowing into the flow meter 162, the water flows through the actuated ball valve 150 as described above. Of course, if the actuated ball valve 150 is closed as determined by the control section 300, no further water flows through the chlorination line 160 and into the chlorinator 200. Water flows into the chlorinator through an inlet 201 and from the chlorinator 200 through an outlet 202.

Water flowing into the non-chlorination line 161 flows directly into a solution tank 205. The flow of water from the non-chlorination line 161 is controlled by a valve 210. In a typical embodiment, the valve 210 is a float valve that includes a large floatation ball 211 that floats on the water stored in the solution tank 205. When the solution tank 205 is full, the ball 211 floats high and shuts off the flow from the non-chlorination line 161. In another embodiment, the valve 210 can be a high/low level switch instead of the float valve.

As described above, the solution tank 205 receives water directly from the non-chlorination line 161. The solution tank 205 further receives water from the outlet 202 of the chlorinator 200, which is indirectly from the chlorination line 160. It is now appreciated that the chlorination line 160 includes water that is to be chlorinated and that the non-chlorination line 161 includes water that is not to be chlorinated. Therefore, it is further appreciated that if the solution tank 205 includes water that is of sufficient chlorine levels, the actuated ball valve remains closed allowing no chlorinated water from the chlorinator 200 to be added to the solution tank 205. However, if the control section 300 determines that the chlorine levels are not sufficiently high, the ball valve 150 is opened to allow water to flow through the chlorination line 160, into the chlorinator 200 and into the solution tank 205.

The solution tank 205 includes an outlet 206 that flows into one or more pumps 170 as mentioned above. The pumps 170 are controlled by the control section 300 and are used to injection the chlorinated water back into the main water line 105 through the outlet 112. Once the treated water flows from the pumps 170, the water flows through a pressure gauge 171 to determine pressure in the system 100. Water pressure can be relieved through a relief valve 172, if necessary. In general, the water continues to flow back toward the main water line 105, passing through a gate valve 173 that controls the back pressure of the pumps 170 to regulate flow toward the outlet 112. The water can pass through a series of additional valves, if necessary.

In a typical embodiment, the chlorinator 200 is similar to the chemical feeder as described in U.S. Pat. No. 5,427,748, which is herein incorporated by reference, and which is now discussed in most pertinent part. It is understood that in other embodiments, additional types of chlorinators can be used.

The chlorinator 200 generally includes a housing 10 having a base 12 and side walls 14. The side walls 14 of the housing 10 are generally vertical and perpendicular to the base 12. The housing 10 can be of any appropriate geometric shape, and is typically cylindrical. Side walls 14 and base 12 generally define a cavity which can be characterized as a hollow cylinder. Within the cavity of the housing 10 is a hollow chamber 20 having side walls 18, which are affixed to the base 12 of the housing 10. Side walls 18 of chamber 20 are spaced form the side walls 14 of the housing 10, generally defining an annular space of cavity, called a collection zone 4.

In general, the upper end of the housing 10 is covered with a removable lid 28. The lid 28 includes an annular channel 27 near its outer edge, which is sized to be slightly larger that the thickness of side wall 14 of the housing 10. An o-ring 26 is located in the annular channel 27 so that when the lid is placed on top of the housing 10 and forced downwardly by latches 30, the interior of the upper storage compartment 8 of housing 10 is sealed against the entry of outside air and possible contaminants. The lid 28 may be secured in place by hinged latches 30. It is understood that any number of appropriate latches 30 can be used. It is further understood that other methods can be used to secure the lid 28. The chlorinator 200 can include a vacuum relief valve 36 so that any vacuum within the chlorinator 200 can be relieved, in particular, to remove cover 28.

Grid 22 in the form of a sieve plate having a plurality of perforations 23 is mounted on top of the side walls 18 of chamber 20, thereby forming a hollow space into which dissolving fluid may be introduced. The grid is spaced from and substantially parallel to the base 12. The grid 22 is located in the housing 10 below the midpoint of a horizontal axis of the housing 10, thereby dividing the cavity within the housing 10 into a major storage compartment 8 for the storage of solid chemical material 1, and a minor lower compartment comprising the collection zone 4 and chamber 20. In a typical embodiment, the grid 22 is a circular plate having a plurality of perforations 23. The grid 22 has a circular channel 21 on its bottom surface to mate with the cylindrical walls 18 of chamber 20. The grid 22 is held in place by the weight of the solid chemical material 1 charged to the storage compartment of the feeder.

The perforations 23 allow the passage of dissolving liquid, typically water, from the chamber 20 into the dissolving zone H to contact the solid chemical material 1. In a typical embodiment, the solid chemical material 1 is calcium hyperchlorite (HTH), which when mixed with the dissolving liquid (water), provides an excellent source of chlorine.

Typically, HTH provides 65% available chlorine and is in a stable form, which is desirable for the implementations as described above. In a typical implementation, the HTH is in the form of 3 inch diameter tablets that are large with respect to the perforations 23 and therefore prevent entrance into chamber 20. In addition, in order to prevent chlorine gas from being released from the HTH, the pH must be kept above a certain point. It is now appreciated that the pH must be monitored and controlled in the system 100, so as to avoid chlorine gas expulsion from the HTH.

Typically, the perforations 23 are also designed to avoid the build-up of pressure in the chamber 20 by the dissolving liquid and to avoid jetting of the dissolving liquid into the dissolving zone- although a billowing or welling-up of the dissolving liquid into the dissolving zone typically results during operation of the chlorinator 200 within the system 100.

The grid 22 includes a flange 24 that extends beyond the side walls of the chamber 20 toward the inside wall of the housing 10. The perimeter of the flange 24 is spaced from the inside wall of the housing to allow passage of the solution of the solid chemical material 1 from the dissolving zone H to the annular collection zone 4. The flange 24 can include perforations 25 and can assist in regulating the volume of liquid flowing into the collection zone 4.

The annular opening 2 between the housing walls 14 and the perimeter of the flange 24 can be varied to regulate the volume and flow rate of the liquid that passes into the collection zone. The annular opening 2 is generally used to prevent build-up of liquid above the dissolving zone in storage compartment 8 over the operating range of the chlorinator 200. The diameter of the outflow discharger 34 additionally assists in the avoidance of build-up of liquid in storage compartment 8. It is appreciated that outflow discharger 34 is coupled to outlet 202.

Dotted line 32 represents the water level within the upper storage compartment 8 during chlorinator 200 operation. The housing inside diameter and height h above grid 22 define the volume of dissolving zone H. The height h of the dissolving zone can vary depending on the area of perforations 25 in the flange 24 and the area of the annular opening 2 as well as the rate of the dissolving liquid charged to the chamber 20 and the diameter of outlet 3. Ideally, the surface area of the solid chemical 1 in contact with the dissolving liquid in the dissolving zone should remain substantially constant during operation of the chlorinator 200.

Inlet conduit 40 and pipe 42 are shown extending through one side of wall 14 of housing 10 and side wall 18 of chamber 20. Inlet pipe 42 is shown as extending to near the opposite inside wall 14 of chamber 20 and as having a plurality of orifices 44, typically in the form of a sparger pipe to allow the passage of liquid into chamber 20. It is appreciated that the inlet conduit 40 and pipe 42 are coupled to inlet 201 of the chlorinator 200. Orifices 44 are shown facing downwardly toward the base 12. In a typical embodiment, the arrangement of the orifices 44 allows the incoming fluid from the chlorination line 160 into the inlet pipe 42 to flow into chamber 20 toward base 12, whereupon it rises through chamber 20 and passes through the perforations 23 in grid 22. The inlet pipe 42 can include a termination plug 46 and be supported by a leg 48.

Liquid flowing from the chlorination line 160 flows into the inlet pipe 42 and exits through orifices 44 into chamber 20. The liquid fills the chamber 20 and passes through grid 22 dissolves solid chemical material 1 in dissolving zone H essentially occupying a volume defined by the area of grid 22 and a height h. The resulting chlorinated solution passes through the annular opening 2 and the perforations 25 in the flange 24, if any, into collection zone 4 and subsequently removed from the collection zone 4 through the outlet conduit 4, then into outlet 202, and into the solution tank 205 as described above.

The chlorinator 200 works on the principle of constant contact between the solid chemical material 1 and the dissolving liquid in the dissolving zone comprising the volume of liquid above the grid 22. The amount of chemical material 1 delivered to the liquid to be treated is varied by controlling the flow rate of dissolving liquid from the chlorination line 160 (the control being attained by the automated control of the actuated ball valve 150) that contacts and dissolves the chemical material 1 within the dissolving zone and the volume of dissolving liquid in contact with the chemical material 1 in the dissolving zone. As the lowermost chemical material 1 dissolves, the additional chemical material 1 moves downward toward the grid 22 under the influence of gravity. When no additional dissolving liquid flows into the dissolving zone, no further dissolving occurs once the solution falls into the collection cavity and through the outflow discharger 34. The remaining solid chemical 1 rests on the grid 22.

In general, it is contemplated that the systems described above can be used in a variety of disinfecting systems other than those used in the poultry processing industry. It is further understood that the use of processing water in poultry processing is used in a variety of implementations. The systems described above and the resulting super-chlorinated water can be used in any of the implementations in poultry processing. For example, chambers having jets to inject super-chlorinated water onto poultry and brushes can be used to clean and disinfect poultry online.

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A method of providing super-chlorinating water to a poultry reprocessing system, comprising:
diverting a side stream of water from a main water flow line;
channeling the diverted water through a chlorinator;
injecting water from the chlorinator into the main water flow line; and
sampling water in a downstream location of the main water flow line for chemical levels.

2. The method as claimed in claim 1, wherein the water sampled from the downstream location is sampled for chlorine levels.

3. The method of claim 1, wherein the water sampled from the downstream location is sampled for pH levels.

4. The method of claim 1, further comprising optionally injecting additional chlorinated water into the main water flow line.

5. The method of claim 1, further comprising optionally injecting a pH adjustment chemical into the main water flow line.
